(19) United States
(12) Patent Application Publication
(10) Pub. No.: US 2010/0150711 A1
(43) Pub. Date: Jun. 17, 2010

(54) APPARATUS AND METHOD FOR PREVENTING CRACKING OF TURBINE ENGINE CASES

(75) Inventor: Gilford Beaulieu, Vernon, CT (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION, Hartford, CT (US)

(21) Appl. No.: 12/333,613

(22) Filed: Dec. 12, 2008

(51) Int. Cl. F01D 9/04; B23P 11/00

(52) U.S. Cl. 415/209.3; 29/889.22

(57) ABSTRACT

A method for preventing cracking of a turbine engine case includes the steps of disposing at least two rails upon an exterior surface of a turbine engine case; and securing a first rail to a first means for attaching at least one fan exit guide vane to the turbine engine case and securing a second rail to a second means for attaching the at least one fan exit guide vane to the turbine engine case.

### FIELD OF THE DISCLOSURE

The disclosure relates to turbine engines cases and, more particularly, relates to an apparatus and method for preventing cracking of turbine engine cases.

### BACKGROUND OF THE DISCLOSURE

Stationary airfoils disposed aft of a rotor section within a gas turbine engine help direct the gas displaced by the rotor section in a direction chosen to optimize the work done by the rotor section. These airfoils, commonly referred to as “guide vanes”, are radially disposed between an inner casing and an outer casing, spaced around the circumference of the rotor section. Typically, guide vanes are fabricated from conventional aluminum as solid airfoils. The solid cross-section provides the guide vane with the stiffness required to accommodate the loading caused by the impinging gas and the ability to withstand an impact from a foreign object.

“Gas path loading” is a term of art used to describe the forces applied to the airfoils by the gas flow impinging on the guide vanes. The magnitudes and the frequencies of the loading forces vary depending upon the application and the thrust produced by the engine. If the frequencies of the forces coincide with one or more natural frequencies of the guide vane (i.e., a frequency of a bending mode of deformation and/or a frequency of a torsional mode of deformation), the forces could excite the guide vane into an undesirable vibratory response. The guide vanes are secured between the inner and outer cases of a turbine engine case by a series of bolts.

Historically, the undesirable vibratory response at times excites the guide vane so much that the guide vane pulls the bolts through the outer case and cracks the case. As a result, the aircraft must be taken out of service in order to repair and/or replace the case and other necessary components.

Therefore, there exists a need to secure the guide vane to the outer case in order to prevent cracking or mitigate existing cracking or cracks.

### SUMMARY OF THE DISCLOSURE

In accordance with one aspect of the present disclosure, a method for preventing cracking of a turbine engine case broadly comprises disposing at least two rails upon an exterior surface of a turbine engine case; and securing a first rail to a first means for attaching at least one fan exit guide vane to the turbine engine case and securing a second rail to a second means for attaching the at least one fan exit guide vane to the turbine engine case.

In accordance with another aspect of the present disclosure, a method for remanufacturing a turbine engine broadly comprises replacing at least one means for attaching at least one fan exit guide vane to a turbine engine case with at least one rail; and securing a first rail to a first means for attaching the at least one fan exit guide vane to the turbine engine case and securing a second rail to a second means for attaching the at least one fan exit guide vane to the turbine engine case.

In accordance with yet another aspect of the present disclosure, a turbine engine broadly comprises a fan section; a low pressure compressor; an engine case disposed about the fan section and the low pressure compressor; and, wherein the engine case comprises at least one rail disposed upon an exterior surface and in connection with a first means for attaching a fan exit guide vane to the engine case for reinforcing the engine case.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a simplified representation of a cross-sectional view of a turbine engine; and

FIG. 2 is a partial representation of a fan exit guide vane and attachment of the present disclosure.

Like reference numbers and designations in the various drawings indicate like elements.

### DETAILED DESCRIPTION

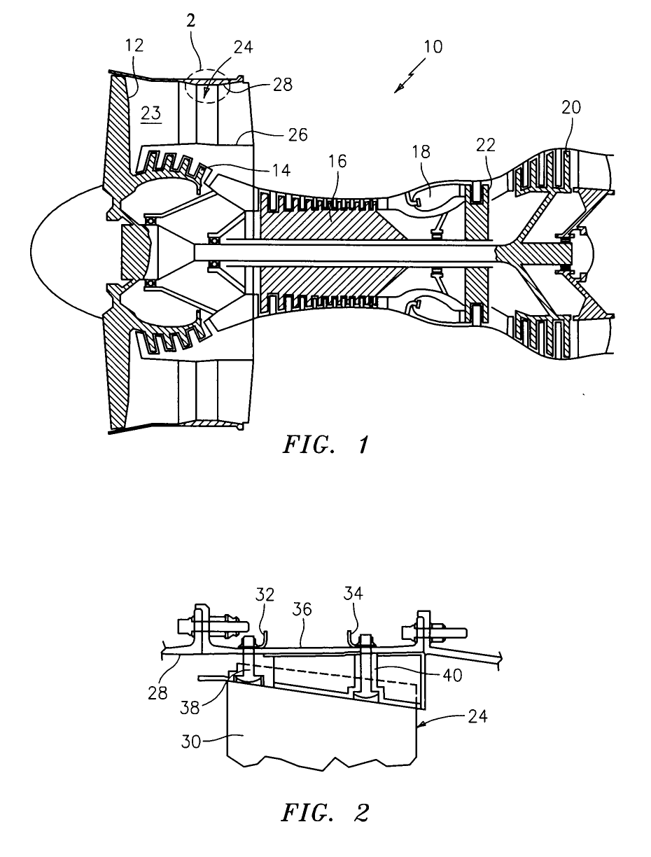

Referring to FIG. 1, a gas turbine engine 10 includes a fan section 12, a low pressure compressor 14, a high pressure compressor 16, a combustor 18, a low pressure turbine 20, and a high pressure turbine 22. The fan section 12 and the low pressure compressor 14 are directly connected to one another and are driven by the low pressure turbine 20. In some configurations, the fan section 12 is driven separately through a gearbox at a lower speed than the low pressure turbine 20. The high pressure compressor 16 is directly driven by the high pressure turbine 22. Air compressed by the fan section 12 will either enter the low pressure compressor 14 as “core gas flow” or will enter a bypass passage 23 outside the engine core as “bypass air”. Bypass air exiting the fan section 12 travels toward and impinges against a plurality of fan exit guide vanes 24, or “FEGV's”, disposed about the circumference of the engine 10. The FEGV's 24 straighten and guide the bypass air into ducting (not shown) disposed outside the engine 10.

Now referring to FIGS. 1 and 2, the FEGV's 24 extend between fan inner case 26 and outer case 28. The inner case 26 is disposed radially between the low pressure compressor 14 and the FEGV's 24 and the outer case 26 is disposed radially outside of the FEGV's 24. Each FEGV 24 includes an airfoil 30 and means for attaching the airfoil 30 between the inner and outer cases 26, 28.

Referring specifically now to FIG. 2, each FEGV 24 may be attached to the outer case 26 by at least one rail, for example, a first rail 32 and a second rail 34, disposed about an exterior surface 36 of the outer case 28. The first rail 32 and second rail 34 may be aligned approximately parallel to one another and secured to the outer case 28 by a first means for attaching 38 and a second means for attaching 40, respectively. Each means for attaching 38, 40 secure each FEGV 24 to the outer case 28 and also secure each rail 32, 34 to the outer case 28. The means for attaching 38, 40 may include at least one of the following: bolts, rivets, screws, and the like, as known to one of ordinary skill in the art.

The rails 32, 34 may be installed where each FEGV 24 is mounted. Each rail may be circumferentially-shaped, or at least substantially circumferentially-shaped, to compliment the shape of the exterior surface of the outer case 28. The rails 32, 34 may distribute the load experienced by the FEGV during operation and help support the outer case 28. As the FEGV vibrates, the rails 32, 34 may prevent the FEGV 24 from pulling the means for attaching through the outer case 28 as well as also prevent the case from cracking. A typical gas turbine engine contains approximately eighty (80) FEGV's, and thus approximately one hundred sixty (160) rails may be installed to stiffen the outer case and either mitigate existing cracking or cracks and/or prevent cracking from occurring. By stiffening the outer case, the entire turbine engine casing may be reinforced to withstand torsional modes of vibration experienced during operation of the turbine engine.

Experimental Section

A pair of rails each having the following dimensions (0.5 inches (12.7 millimeters)×0.5 inches (12.7 millimeters)×3.0 inches (76.2 millimeters)) and composed of 0.0625 inches (1.5875 millimeters) thick sheet metal were bolted to a piece of an outer case and an FEGV. The structure was mounted to a hydraulic cylinder and a simulated air load was applied. One cycle constituted one stroke actuated by the hydraulic cylinder upon the structure. After subjecting the structure to ten-thousand (10,000) cycles, no crack growth was observed in the outer case and the outer case maintained an overall stiffness of between approximately eighty percent (80%) to approximately one hundred percent (100%) of the original stiffness.

One or more embodiments of the present disclosure have been described. Nevertheless, it will be understood that various modifications may be made without departing from the spirit and scope of the disclosure. Accordingly, other embodiments are within the scope of the following claims.

What is claimed is:

1. A method for preventing cracking of a turbine engine case, comprising:
disposing at least two rails upon an exterior surface of a turbine engine case; and
securing a first rail to a first means for attaching at least one fan exit guide vane to said turbine engine case and securing a second rail to a second means for attaching said at least one fan exit guide vane to said turbine engine case.

2. The method of claim 1, wherein disposing comprises the steps of:
placing said first rail in connection with said first means for attaching;
placing said second rail in connection with said second means for attaching; and
aligning said first rail approximately parallel to said second rail.

3. The method of claim 1, wherein disposing further comprises disposing at least two circumferentially-shaped rails.

4. A method for remanufacturing a turbine engine, comprising:
replacing at least one means for attaching at least one fan exit guide vane to a turbine engine case with at least one rail; and
securing a first rail to a first means for attaching said at least one fan exit guide vane to said turbine engine case and securing a second rail to a second means for attaching said at least one fan exit guide vane to said turbine engine case.

5. The method of claim 4, wherein stiffening comprises the steps of:
placing said first rail in connection with said first means for attaching;
placing said second rail in connection with said second means for attaching; and
aligning said first rail parallel to said second rail.

6. A turbine engine, comprising:
a fan section;
a low pressure compressor;
an engine case disposed about said fan section and said low pressure compressor; and
wherein said engine case comprises at least one rail disposed upon an exterior surface and in connection with a first means for attaching a fan exit guide vane to said engine case for reinforcing said engine case.

7. The turbine engine of claim 6, wherein said at least one rail further comprises a first rail connected to said exterior surface and said first means for attaching, and a second rail connected to said exterior surface and a second means for attaching.

8. The turbine engine of claim 6, wherein said at least one rail further comprises at least one circumferentially-shaped rail.

9. The turbine engine of claim 8, wherein said at least one circumferentially-shaped rail comprises a substantially circumferential shape that is complimentary to said exterior surface of said engine case.
